(19) United States
(12) Patent Application Publication
(10) Pub. No.: US 2019/0012184 A1
(43) Pub. Date: Jan. 10, 2019

(54) SYSTEM AND METHOD FOR DEPLOYING CLOUD BASED COMPUTING ENVIRONMENT AGNOSTIC APPLICATIONS

(71) Applicant: CloudEndure Ltd., Ramat Gan (IL)

(72) Inventors: Leonid FEINBERG, Ramat HaSharon (IL); Ofir EHRLICH, Netanya (IL); Eran WEISS, Givataim (IL); Ophir SETTER, Ramat Gan (IL)

(73) Assignee: CloudEndure Ltd., Ramat Gan (IL)

(21) Appl. No.: 15/855,512

(22) Filed: Dec. 27, 2017

Related U.S. Application Data
(60) Provisional application No. 62/528,507, filed on Jul. 4, 2017.

(51) Int. Cl. G06F 9/4401; H04L 29/08; G06F 8/61; G06F 9/455

(52) U.S. Cl. CPC G06F 9/4416; H04L 67/34; G06F 2009/45595; G06F 8/63; G06F 9/45558; G06F 9/4406

(57) ABSTRACT

A system and method for deploying a cloud-agnostic appliance. The method includes generating an image file of a virtual appliance, wherein the image file includes a primary operating system (OS), a boot OS, and an application; deploying the image file in a cloud based computing environment (CBCE); sending the boot OS configuration instructions for configuring the virtual appliance to operate in the CBCE; and configuring the virtual appliance to reboot from the primary OS.

### CROSS-REFERENCE TO RELATED APPLICATIONS

This application claims the benefit of U.S. Provisional Application No. 62/528,507 filed on Jul. 4, 2017, the contents of which are hereby incorporated by reference.

### TECHNICAL FIELD

The present disclosure relates generally to cloud based computing environments, and more specifically, to deploying cloud based computing environment agnostic applications.

### BACKGROUND

Cloud based computing environments (CBCE) allow for greater flexibility and scalability in deploying services and resources on demand when compared to traditional local computing environments. Sharing hardware resources among multiple systems is more efficient and often more economical, allowing for investment in fewer computing resources while maintaining the ability to provide the same level of computing power and storage to run multiple applications thereon. However, many cloud based computing environments only support a limited set of machines, operating systems, or applications. This limits the effective use of a CBCE, and may require that each application that is executed within the environment be customized and tailored for that particular environment. Two CBCEs may differ substantially, such that in order to run an application on a second CBCE that has been designed to run on a first CBCE, the application must be rewritten and created anew. Rewriting applications for various platforms is inefficient and costly, and can become prohibitively expensive if the application is required to work on multiple CBCEs. The ability to execute a single application on many platforms without having to rewrite or recreate the application offers more compatibility and increased efficiency, thus reducing costs.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for deploying a cloud-agnostic appliance. The method includes generating an image file of a virtual appliance, wherein the image file includes a primary operating system (OS), a boot OS, and an application; deploying the image file in a cloud based computing environment (CBCE); sending the boot OS configuration instructions for configuring the virtual appliance to operate in the CBCE; and configuring the virtual appliance to reboot from the primary OS.

Certain embodiments disclosed herein also include a non-transitory computer readable medium having stored thereon instructions for causing a processing circuitry to perform a process. The process includes generating an image file of a virtual appliance, wherein the image file includes a primary operating system (OS), a boot OS, and an application; deploying the image file in a cloud based computing environment (CBCE); sending the boot OS configuration instructions for configuring the virtual appliance to operate in the CBCE; and configuring the virtual appliance to reboot from the primary OS.

Certain embodiments disclosed herein also include a system for deploying a cloud-agnostic appliance, comprising: a processing circuitry; and a memory, the memory containing instructions that, when executed by the processing circuitry, configure the system to: generate an image file of a virtual appliance, wherein the image file includes a primary operating system (OS), a boot OS, and an application; deploy the image file in a cloud based computing environment (CBCE); send the boot OS configuration instructions for configuring the virtual appliance to operate in the CBCE; and configure the virtual appliance to reboot from the primary OS.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a CBCE-agnostic virtual appliance according to an embodiment.

FIG. 2 is a network diagram for describing certain embodiments of a system for implementing a CBCE-agnostic virtual appliance.

FIG. 3 is a block diagram of a configuration server of a CBCE-agnostic system according to an embodiment.

FIG. 4 is a flowchart of a method for implementing a CBCE-agnostic virtual appliance according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

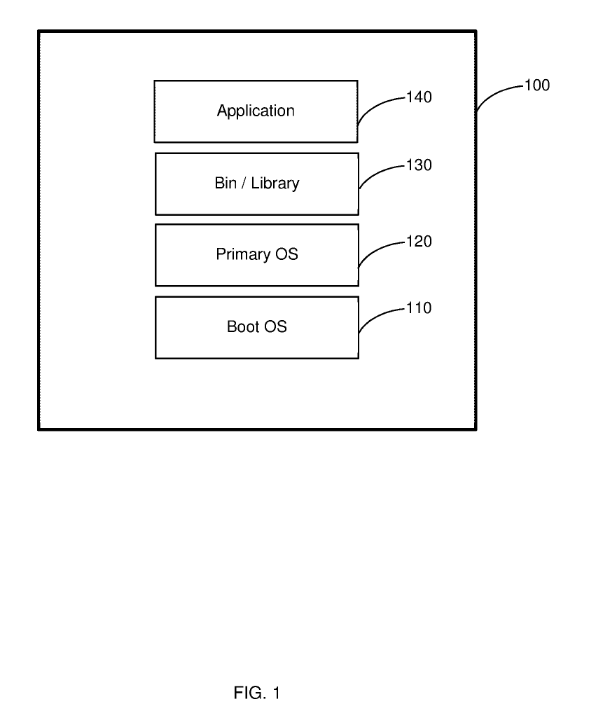

FIG. 1 is a block diagram of a CBCE-agnostic virtual appliance 100 according to an embodiment. A virtual appliance 100, also referred to as an image file or a virtual machine image file, is a self-contained file configured to be run on a virtual platform, such as a CBCE, regardless of the underlying system, and may be implemented using a hypervisor as discussed herein below.

The virtual appliance 100 includes a boot operating system (OS) 110, a primary operating system (primary OS) 120, a set of binaries or libraries 130 to be used with the primary OS 120, and at least one application 140 utilizing the binaries or libraries 130 and configured to run on the primary OS 120. In some embodiments, various elements may be either excluded from the virtual appliance 100, or two or more elements may be combined into a single element. For example, the boot OS 110 and the primary OS 120 may be implemented as a single operating system. Only essential parts of both the boot OS 110 and primary OS 120 may be included in the image file 100 according to an embodiment, allowing for a smaller and more efficient file size and allowing the application 140 to be executed more efficiently within the CBCE. Additionally, in another embodiment only necessary portions of the binaries or libraries 130 may be included, reducing the size of the image file by excluding extraneous portions thereof.

The virtual appliance 100 may be executed on a machine which is part of a CBCE, such as a virtual machine or a physical machine connected to a network. The machine may include access to resources, such as a processing circuitry, memory, storage, and network access, configured to run the application using the boot OS 110, the primary OS 120, and the binaries or libraries 130, within the CBCE. Components of the machine may be shared by one or more additional machines within the CBCE, and may be employed to execute a plurality of virtual applications, either concurrently or consecutively.

The application 140 may include a program designed to carry out a particular function, such as a firewall, a web server, a database server, a cache server, a network architecture management service, a load balancing service, an auto-scaling service, a content delivery network (CDN) service, a network addresses allocation service, a database service, a domain name system (DNS) service, any combination thereof, and the like. As explained below, the virtual appliance 100 may be configured to allow the application 140 to run on a variety of CBCEs, allowing for deployment of a single version of the virtual appliance 100 over multiple systems without requiring customization of the application 140 for each individual system.

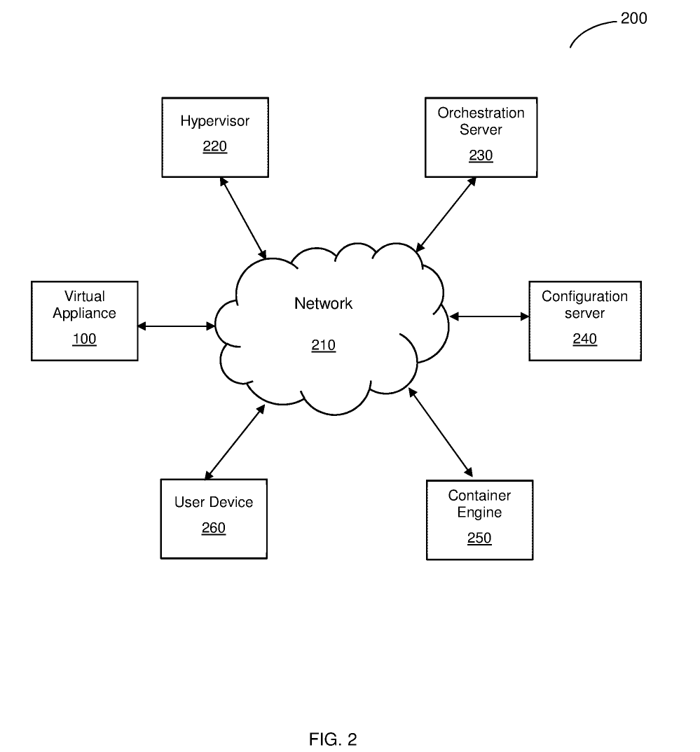

FIG. 2 is a network diagram for describing certain embodiments of a system 200 for implementing a CBCE-agnostic virtual appliance. The system 200 includes a virtual appliance 100, a hypervisor 220, an orchestration server 230, and a configuration server 240 connected via a network 210. The network 210 may include, but is not limited to, a wired or wireless network, such as a local area network (LAN), a wide area network (WAN), a metro area network (MAN), the worldwide web (WWW), the Internet, a virtual private network (VPN), any combination thereof, and the like. Connectivity among the various components of the system is provided by the network 210.

A virtual appliance 100, such as the virtual appliance of FIG. 1, is accessible over the network 210. The virtual appliance 100 may be accessed by the orchestration server 230, for example by receiving an image file over the network. The orchestration server 230 is configured to provide hardware resources from the cloud computing environment to the virtual appliance 100. Resources include hardware resources employed when executing applications, such as processing circuitry, memory, storage, network capability, and the like. The orchestration server 230 may also provide configuration for the virtual appliance 100, such as granting network access to additional logical and physical components of the CBCE.

Some CBCEs may include one or more hypervisors 220. A hypervisor 220 may be software, hardware, firmware and the like, that is configured to manage virtual machines (VM, not shown), allowing the hosting of multiple VMs on a single hardware. The VM may include a web server, a database server, a cache server, virtual appliances, and the like. Each VM may include a separate OS running various applications and is granted access to certain hardware resources. The hypervisor 220 allocates the appropriate resources to each VM as needed. In some embodiments, the hypervisor 220 may run a VM providing a service, such as a network architecture management service, load balancing service, auto scaling service, content delivery network (CDN) service, network addresses allocation service, database services, domain name system (DNS) services, and the like.

The hypervisor 220 may comprise a hosted hypervisor or a native hypervisor. A hosted hypervisor is run on a host OS, where the host OS directly controls the hardware resources and the hosted hypervisor controls the VM. Conversely, a native hypervisor is run directly on a hardware, and controls both the hardware resources as well as the VMs running thereon. Both versions of the hypervisor 220 allow for execution of one or more virtual appliances 100 on a single hardware within the VM. Each VM may run a primary OS that is configured to execute an application, regardless of the platform of the underlying hardware. The primary OS may be initiated from a boot OS, where the boot OS allows for basic commands over a broad array of hardware, such as creating a basic connection to a configuration server. Thus, the hypervisor 220 allows multiple VMs to run multiple OSs using a single hardware. In an embodiment, the hypervisor 220 adjusts the availability of the hardware resources to each VM in order to optimize efficiency of the system. For example, if a first VM is running an application that requires minimal storage space but ample processing power, and a second VM is running an application that requires minimal processing power, but significant memory and storage, the hypervisor allocates the resources of the underlying hardware accordingly to allow both applications to run efficiently.

In an embodiment, the CBCE system 200 includes one or more container engines 250 that are configured to run one or more applications on a single OS, isolated from each other while sharing the resources of the OS and the underlying hardware resources allocated to the container engine 250. Thus, a single hardware running a single OS may nonetheless run multiple isolated applications, e.g., from a virtual appliance 100, within a CBCE.

A configuration server 240 is designed to configure a virtual appliance 100 to operate in a CBCE having a specific underlying system. As an example, the virtual appliance 100 may include an image file which is configured to run a load balancing service between a first webserver running on a first VM of a hypervisor 220, a second webserver running on a second VM of the hypervisor 220, and a third webserver running on a container engine 250. The configuration server 240 may send configuration instructions for the load balancing application to enable the application to communicate with the first VM, the second VM, and the container. In some embodiments, the instructions may originate from a user device 260 connected to the network. For example, the user device 260 may send the configuration instructions to the configuration server 240, which in turn configures the application, either by communicating directly to it or by sending instructions to the orchestration server 230, which are then passed to the application. A user device 260 may include, for example, a personal computing device, a laptop, a smart phone, a tablet, and the like.

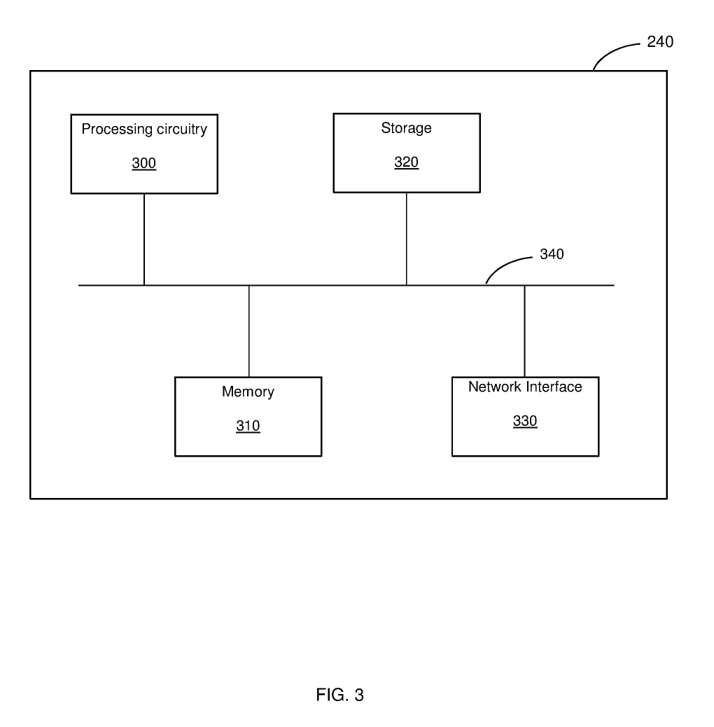

FIG. 3 is a block diagram of a configuration server 240 of a CBCE-agnostic system according to an embodiment. The configuration server 240 includes a processing circuitry 300, a memory 310, and a storage 320. In an embodiment, the memory 310 includes instructions to configure a virtual appliance to operate in a specific CBCE, as discussed in FIG. 2 above. The configuration server 240 may further include a network interface 330 adapted to connect the configuration server 240 to a network. In an embodiment, the components of the configuration server 240 may be communicatively connected via a bus 340.

The processing circuitry 300 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 310 may be a volatile memory such as, but not limited to, random access memory (RAM), or non-volatile memory (NVM), such as, but not limited to, flash memory. In an embodiment, the memory 310 is configured to store software. Software shall be construed broadly to mean any type of instruction, whether referred to as software, firmware, middleware, microcode, hardware description language, or otherwise. Instructions may include code (e.g., in source code format, binary code format, executable code format, or any other suitable format of code). The instructions, when executed by the processing circuitry 300, perform the various processes described herein. The software may include instructions to execute commands of the configuration server 240.

The storage 320 may include one or more disks, such as magnetic hard disk drives, solid state drives, network-attached storages (NAS), storage area network (SAN) disks, and the like. The network interface 330 may be configured to allow a wired or wireless connection between the configuration server 240 and a network.

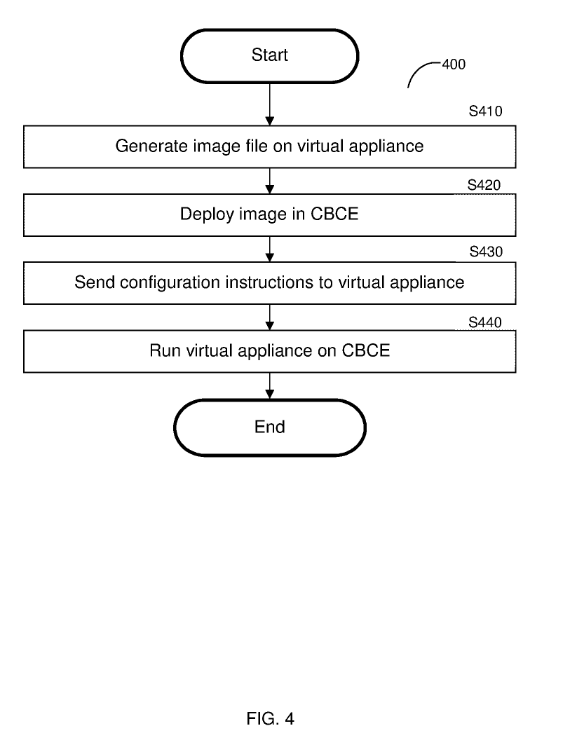

FIG. 4 is a flowchart of a method 400 for implementing a CBCE-agnostic virtual appliance according to an embodiment. At S410, an image file is generated of at least one virtual appliance. The image file may include a primary OS, binaries, libraries, and at least one application. In some embodiments, the image file may additionally include a boot OS, which allows for basic functionality more limited in capability than the primary OS but compatible with multiple CBCEs. The boot OS allows initiation of a connection between the virtual appliance and a configuration server. The primary OS may be the boot OS in an embodiment.

At S420, the image file is deployed in a CBCE. In an embodiment, the image file is caused to be deployed by an orchestration server configured to allocate resources, such as hardware resources, of the CBCE to the at least one virtual appliance, and may in some embodiments configure the virtual appliance to boot from the boot OS. The CBCE is configured to allow an initiated image to open a port for network communication. In an embodiment, the boot OS may be configured to open a port for the configuration server to connect thereto. The configuration server may send the boot OS instructions which cause the boot OS to configure the primary OS or the application of the image file to run in the CBCE. For example, the application may be a load balancer configured to serve three host servers. The boot OS may receive instructions to configure a load balancer application to communicate with each of the three host servers, to determine a priority for each host server, and so on. Deploying the image file may include, in some embodiments, sending to the orchestration server at least one of: the image file, a network accessible location of the image file, and an identifier of the image file in the CBCE.

At S430, the configuration server sends configuration instructions to the virtual appliance through the CBCE. The configuration instructions may instruct the boot OS of the virtual appliance to configure, for example, at least one of: the primary OS, binaries, libraries, and at least one application. Upon receiving the configuration instructions and executing them, the boot OS may cause the virtual appliance to reboot with the primary OS. In some embodiments, the configuration server may send the virtual appliance an instruction to reboot with the primary OS. The configuration instructions may include which aspects of the primary OS, the binaries, and the libraries are necessary to invoke to successfully execute the application within the CBCE. Thus, the virtual appliance is adjusting for optimal compatibility with the CBCE by only using necessary components that are compatible with that particular CBCE. At S440, the virtual appliance is executed on the CBCE.

In some embodiments, the virtual appliance may be installed on a machine connected to a network. The machine includes a monitoring agent, which may monitor, for example, resource use and access, such as disk use and access, memory use and access, network use and access, and the like, when the virtual appliance is being executed. The monitoring agent is configured to send to a replicating server information about the resource use and access in order to replicate the machine in a CBCE. An orchestration server may initiate a virtualization object (such as a virtual machine or a container), and the monitoring agent may send an image file of the virtual appliance from the machine over the network to the virtualization object, such as to a replicated virtual machine or container. The appliance may then be configured by the configuration server to operate in the cloud-based computing environment.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for deploying a cloud-agnostic appliance, comprising:
generating an image file of a virtual appliance, wherein the image file includes a primary operating system (OS), a boot OS, and an application;
deploying the image file in a cloud based computing environment (CBCE);
sending the boot OS configuration instructions for configuring the virtual appliance to operate in the CBCE; and
configuring the virtual appliance to reboot from the primary OS.

2. The method of claim 1, wherein sending the boot OS configuration instructions includes configuring to operate in the CBCE at least one of: the primary OS and the application.

3. The method of claim 1, wherein the image file further comprises at least one of: a binary file and a library file.

4. The method of claim 3, wherein sending the boot OS configuration instructions further comprises:
identifying aspects of the primary OS, the binary files, and the library files that are necessary to successfully execute the application in the CBCE.

5. The method of claim 1, wherein multiple virtual appliances are deployed within the CBCE.

6. The method of claim 5, wherein the multiple virtual appliances are executed on a single hardware device.

7. The method of claim 1, wherein the application includes at least one of: a firewall, a web server, a database server, a cache server, a network architecture management service, a load balancing service, an auto-scaling service, a content delivery network (CDN) service, a network addresses allocation service, a database service, and a domain name system (DNS) service.

8. The method of claim 1, further comprising:
determining resources use and access when the virtual appliance is being executed.

9. The method of claim 8, wherein the determined resource use is sent to a virtualization object, and wherein the virtualization object is configured to execute the virtual appliance.

10. A non-transitory computer readable medium having stored thereon instructions for causing a processing circuitry to perform a process, the process comprising:
generating an image file of a virtual appliance, wherein the image file includes a primary operating system (OS), a boot OS, and an application;
deploying the image file in a cloud based computing environment (CBCE);
sending the boot OS configuration instructions for configuring the virtual appliance to operate in the CBCE; and
configuring the virtual appliance to reboot from the primary OS.

11. A system for deploying a cloud-agnostic appliance, comprising:
a processing circuitry; and
a memory, the memory containing instructions that, when executed by the processing circuitry, configure the system to:
generate an image file of a virtual appliance, wherein the image file includes a primary operating system (OS), a boot OS, and an application;
deploy the image file in a cloud based computing environment (CBCE);
send the boot OS configuration instructions for configuring the virtual appliance to operate in the CBCE; and
configure the virtual appliance to reboot from the primary OS.

12. The system of claim 11, wherein sending the boot OS configuration instructions includes configuring to operate in the CBCE at least one of: the primary OS and the application.

13. The system of claim 11, wherein the image file further comprises at least one of: a binary file and a library file.

14. The system of claim 13, wherein sending the boot OS configuration instructions further comprises:
identify aspects of the primary OS, the binary files, and the library files that are necessary to successfully execute the application in the CBCE.

15. The system of claim 11, wherein multiple virtual appliances are deployed within the CBCE.

16. The system of claim 15, wherein the multiple virtual appliances are executed on a single hardware device.

17. The system of claim 11, wherein the application includes at least one of: a firewall, a web server, a database server, a cache server, a network architecture management service, a load balancing service, an auto-scaling service, a content delivery network (CDN) service, a network addresses allocation service, a database service, and a domain name system (DNS) service.

18. The system of claim 11, wherein the system is further configured to:
determine resources use and access when the virtual appliance is being executed.

19. The system of claim 18, wherein the determined resource use is sent to a virtualization object, and wherein the virtualization object is configured to execute the virtual appliance.
